(19) United States
(12) Patent Application Publication
(10) Pub. No.: US 2014/0282979 A1
(43) Pub. Date: Sep. 18, 2014

(54) USER AUTHENTICATION SYSTEMS FOR REMOTE COMPUTERS, INTERNET APPLICATIONS AND ONLINE SERVICES

(71) Applicant: Charles A. Andon, Nashua, NH (US)

(72) Inventor: Charles A. Andon, Nashua, NH (US)

(21) Appl. No.: 14/217,455

(22) Filed: Mar. 17, 2014

Related U.S. Application Data
(60) Provisional application No. 61/802,304, filed on Mar. 15, 2013.

(51) Int. Cl. H04L 29/06

(52) U.S. Cl. CPC H04L 63/0884
USPC 726/7

(57) ABSTRACT

A system for authenticating users to a remote computers, networks and applications is provided whereby a user provides a remote system with basic identification, the remote system contacts an authentication server, the authentication system provides the user with one or more graphical challenge interfaces that require a user to select specific locations in one or more graphics to prove his identity, where the user has previously chosen the graphics and specific locations, the graphics and specific locations are stored securely in the authentication server, and successful identification of the preselected locations authenticates the user to the remote computer, networks and/or application.

This application claims the benefit of priority to U.S. provisional application 61/802,304 filed Mar. 15, 2013 which is hereby incorporated by reference

### BACKGROUND OF THE INVENTION

Internet and mobile services have made it possible for users to access content and applications from almost anywhere in the world using a wide variety of devices such as computers, tablets, smartphones and the like. A consumer can access his bank, brokerage or retirement accounts, pay utility bills online, shop merchant websites, and participate in online conversations using social media.

Similarly, employees of businesses no longer need to be at a fixed office to perform their duties. They can access business systems to perform their jobs from home or the road. Similarly, businesses can create virtual teams of employees and independent contractors spread around the world to work on critical projects.

However, this increased remote access has generated new security challenges and new opportunities for criminals. In order to limit access to authorized parties (i.e. the consumer who owns a given bank account or employee), operators of systems accessible via the Internet or other remote connection use authentication protocols to attempt to limit access to the authorized user. Many of these systems have limitations that make them vulnerable to attack by criminals. In order to use one of these services, the user must generally provide some sort of authentication. Typically, this is a password. However, one of the greatest weaknesses is the use of alphanumeric passwords to access remote systems.

In most systems, the user creates a password at the time her account is created. While some systems require some combination of lowercase and uppercase letters, numbers, and special characters, most simply require letters and numbers. The problem with this approach is that the human mind performs poorly at memorizing random strings of characters. As a result, users typically use words or strings that they can memorize easily or write down difficult-to-remember passwords.

Simple-to-remember passwords are vulnerable to “dictionary” attacks, where hackers try commonly used words and phrases or known public information specific to a target user (ie names of spouses and children). Complex passwords that cannot be easily memorized are often written down and carried by the user with them, which is a poor security practice undermining the “strong” password.

Password-based systems are also vulnerable to shoulder-surfing—where a person or camera records the action of a user entering a password—and keyloggers—where a concealed electronic device intercepts uncoded passwords after entry and transmits this data to a criminal elsewhere.

Similarly, a criminal may use “bot” technology where a site is accessed repeatedly by software robots that click on various points in the page or enter text to attempt to obtain access to a system. Networks of multiple computers running robot programs, (“a botnet”) may launch thousands or millions of attempts to access a protected service.

One potential solution to this problem is dual factor authentication, where the user is in possession of a device (such as an ID card or token) that provides additional authentication or enters a code that has been transmitted to the user (often as a text message to a cell phone). The drawback to this approach is that the user needs the token or cell phone in his possession to authenticate himself to the system, which is especially problematic if the token or cell phone is lost or stolen.

Accordingly, it is desirable to use a user authentication protocol that is resistant to brute force and bot attacks and does not require access to a physical device on the user's person. It is also desirable that the user authentication system take advantage of the strengths of the human mind.

While most humans are limited in their abilities to recall strings of text, numbers and special characters, humans have a much greater ability to recall other types of data, such as images, music and the like.

Accordingly, it desirable to create an authentication system using data that humans process as well or, better than machines. In a preferred embodiment this takes the form of a graphic interface where the user selects a point or area in the graphic to authenticate herself to the system. The point to be selected can either be a “keyhole” or specific preselected point or location in a preselected image or a graphic that is incorporated into an image. Preferably the graphical interface incorporates motion, so that the location to be selected and the time the graphic appears varies, making the system resistant to keylogger and bot technologies.

In one embodiment, the user designates or creates a specific symbol or glyph at the time of the creation of his account. When the user seeks to access the protected service, the authentication system generates a graphic display containing the glyph. For example, the graphical display may include multiple spheres or bubbles, one or more of which may be actively in motion, each containing indicia, where only one bubble contains the user's glyph. The user is then given a short period of time to find and select the bubble containing his glyph.

In another embodiment, the user designates a point in an image as their “keyhole” to obtain access. The system can allow a user to upload his own images or the user may select an image from stock photos, preferably images with a considerable amount of detail. The points to be selected may be a person, place or thing, such as face in a group photo, a point on an image of a shoreline, or a specific flower in a flower garden photograph. The points to be selected may be selected in any number or order, with each successive “keyhole” increasing the security thereof, but in one embodiment there are specifically three keyholes selected in the order person, place, and then thing.

An another embodiment, the system uses rhythmic tapping as the authentication procedure. For example, the user can store a specific tapping rhythm as his authentication protocol. This may be integrated with a graphic interface where the user must enter this rhythm in a specific sections of the touchscreen surface or enter a present number of taps when a preselected image is displayed on the screen.

It is preferable to incorporate a delay into the system since botnets typically rely upon instantaneous action, where humans will have the patience to wait until the correct image actually appears.

It is desirable that the system be game-like, so that a user's enjoyment of the “game” will be encourage her to recall the predetermined locations while making the system difficult to break using brute force or code-breaking techniques.

It is also desirable to use an application system of the invention as a form of federated or open identification system, where the user can access multiple services using a single login.

### DESCRIPTION OF THE DRAWINGS

FIG. 1 shows the first embodiment of the invention using moving bubbles containing glyphs where the user is to select the bubble containing his preselected glyph.

FIG. 2 shows a second embodiment of the invention where the user must select a predesignated person from a group photo.

FIG. 3 shows an alternative or additional version of the second embodiment of the invention where the user must select a predetermined place from a map or aerial photo.

FIG. 4 shows an alternative or additional version of the second embodiment of the invention where the user must select a predetermined thing or object from a photograph.

FIG. 5 shows a flowchart showing the use of an embodiment of the authentication system of the invention to access a remote system.

FIG. 6 shows a flowchart showing the system of FIG. 5 where the authentication system is communicating with the user's desktop or tablet.

FIG. 7 shows a flowchart showing the user securely connected to the remote system after being authenticated by the system.

FIG. 8 shows a “secure desktop” version of the system where the authentication provider communicates with remote service providers after the user has been authenticated by the system.

### DETAILED DESCRIPTION

To use the authentication system of the invention, the user must first set up an account with the authentication service provider, which may or may not be the provider of the remote application to be accessed. In practice the authentication service provider is likely to not be the remote application provider.

It is envisioned that remote services may contract with the authentication service provider to verify identities of their users. In such a case, when a user wishes to access protected content, the remote service will then utilize the authentication service to verify a user's identity prior to granting access to the remote service.

In a first embodiment of the system, a user account is created that includes information that is used to verify the user's identity by the authentication provider. In addition to standard fields (name, email, address, phone, etc.) and application specific fields, the user must enter a glyph (a graphic symbol). This symbol may be entered via mouse, stylus, fingertip, or any other graphic interface. Alternately, the user may choose from a selection of glyphs already incorporated into the system. The selected glyph is the object that the user must then locate in a graphic login screen in order to authenticate himself to the system. In the example shown in FIG. 5, the user's glyph is a hand-drawn spiral.

When the user goes to the site of the remote system using the authentication system, the user first identifies himself to the system using his username, which may be an email address. The authentication system may optionally include a standard alphanumeric password as a first level of security.

Turning now to FIG. 5, to access a remote system, the user either navigates to the website of the remote system or selects the favicon 10 corresponding to the remote service 100 on a desktop or tablet screen 20. The remote system 100 then contacts the authentication server 200. The authentication service provider is preferably located at an authentication service provider data center 300 that also comprises a secured server 250 where authentication data is stored.

The authentication server 200 then accesses the secured server 250 to find the user's authorization data (in this case, a glyph). The authentication server 200 then communicates back to the user's personal screen or tablet 20 with the graphical interface, as shown in FIG. 6.

The user will then be presented with a graphic interface, such as that shown in FIG. 1. In the first embodiment of the invention, a number of moving bubbles, appear on the screen 500, each bubble containing a glyph. Preferably the bubbles move in an unpredictable manner, such as bobbling on the surface of a simulated body of water. The bubbles periodically “pop” and vanish, making the user wait if he cannot initially locate his glyph.

Once the user sees his glyph he selects it by clicking on it using a circle 510 or touching it through a graphic user interface. In the embodiment shown in FIG. 1, the glyph that looks like a spiral or “@” symbol is the user's preselected glyph. Once the bubble containing that symbol is selected, the user has is then authenticated into the system. In this embodiment, the bubbles are capable of overlapping and concealing one another in addition to appearing and disappearing. As a result, the user may have to wait for the bubble containing his glyph to appear and be spaced apart from other “false” bubbles.

In order to confirm that a user has selected his glyph, when he selects a point in the image through mouseclick or touch, the system then determines whether the user's glyph was located at, or sufficiently near, the point selected by the user at the time the selection was made. If the user has correctly selected his preset glyph in the moving image, the authentication system 200 will then indicate the user is who he claims to be to the remote service 100 and enable secured access as shown by FIG. 7.

If the user selects the wrong bubble or misses the correct bubble more than a present number of times, the system will then lock out the user. This lockout be limited to the current IP address from which the user seeks to access the system or may be a complete account lockout, requiring the user to go through a reset password protocol of the type known in the art.

Any sort of shape containing a glyph may be suitable for this embodiment's authentication. For example, the “bubbles” could be soap bubbles or balloons floating in the wind, squares moving in a grid, rubber ducks floating downstream, fish swimming in a fish tank, or the like, so long as the marked object preferably moves in an unpredictable fashion and/or is capable of disappearing and reappearing.

In a second embodiment of the invention, the user must select a “keyhole” or specific portion of an image in one or more graphics. For example, the “keyhole” could be a person's face in a group photo, a building in a city view, a specific object in a large photo. Instead of, or in addition to, creating a glyph during the account set-up process, the user marks a portion of one or more graphics as a “keyhole.” In one embodiment, the images are of sufficient size that the entire image cannot be viewed on screen, requiring the user to either pan the image to find the keyhole or to zoom in to select features.

For example, a user might create a series of keyholes designating a person, place and thing. On the first screen, the user would be presented with a photograph of people and would be required to select a specific person in the photograph. As shown in FIG. 2, the first image could be a group photo 600, where the user must select the face of the a specific person 610, as indicated by the square which is supplied for illustrative purposes.

For a place, the user may have to select a specific building in a map or overhead image. As shown by the aerial view 700 in FIG. 3, a specific building 710 is designated as the place where the user's keyhole is, as indicated by the square which supplied for illustrative purposes.

For a thing, the user will have to select a specific thing in a third image. FIG. 4 shows a close-up version 800 of the aerial photograph in FIG. 4, where the “thing” is a satellite dish 810 on the roof.

The system could include additional security features such as making the image move through wraparound vertical or scrolling, or with noise, stretching, blurring, cropping, color-shifting, resizing, resampling, waves, watermarks, or other graphical or algorithmic affects added to the image. The system could also display a large image requiring the user to zoom into it to locate the pre-selected part of the image. Alternatively, the system could display a series of images where the user's image is one in a series of images that dissolve into the next image.

In a third embodiment of the invention, the user must establish a “rhythm” consisting of a series of taps, clicks, or swipes made on a given location or locations of a screen in a specific and repeatable cadence. For example, the “rhythm” could be a simple series of taps on the screen of a mobile device, in a musical beat or in such a cadence as to be familiar to and known only by the user. In one embodiment, the screen presented is black or contains only a single dot on the screen, with no other visual imagery or sounds to provide clues as to what rhythm is being tapped by the user, such that any person or any camera attempting to “shoulder-surf” the rhythmic password would be unable to ascertain the cadence visually or audibly. In this case, the rhythm would be the identification information stored in the secure server 250 and the authentication system would use musical pattern recognition as known in the art.

In another embodiment shown in FIG. 8, the authentication system is integrated with the remote protected applications as part of a secured desktop and effectively serves as a global password. When the user creates his account with the authentication service provider, he also includes access information (logins and passwords) for participating remote services or security partners, such as social media sites like Facebook, retailers like Amazon, or banking websites.

Once the user has been authenticated, he will then be presented with a desktop that includes icons for protected remote services. When the icon for a remote service is selected, the user is logged directly onto the remote service rather than just opening the service's web site for the user to enter a new set of credentials. Instead, the authentication service contacts its server 200, transmitting a message with the authentication service's customer's identification and an authorization code that the customer wants to connect to the remote service and has been authenticated.

The authentication service server then looks up the corresponding login for the remote service, preferably stored and encrypted on a separate server 250 in a data center 300 maintained by authentication service provider, decrypts it, contacts the remote service's server and communicates the user's login credentials for the remote service (ie [bank username] and [bank password]) along with the user's IP address, a confidence level, and a transaction key.

Then once the remote service's server verifies the credentials provided by the authentication service and transmits a http secure link back to the secure desktop which is valid for a short period of time (e.g. 5 seconds) and only from the provided IP address. The http secure link is then opened by the secure desktop and the user is logged into the remote service without having to log into the application.

This approach enables a remote service provider to provide a greater level of security without inconveniencing their users. Rather than making changes to their customer-facing pages; remote services simply have to build a secure bridge from their server to the authentication service server, using modules, protocols, and/or API's (Application Programmer's Interfaces). Implementation of a back-end, server-to-server secure communication conduit or “bridge” is minimal risk for the remote service provider, and relieves them from constantly needing to update their security protocols. Instead, they can outsource authentication to the authentication service provider where the critical information remains largely within the walls of the authentication service provider's data center, leaving only basic code on the desktop or smartphone to provide relays between the secure desktop and the authentication service server, avoiding the retention of critical data on the computer or phone.

The remote service provider retains the ability to request additional information, like a secondary password or challenge/response question, if it doesn't recognize the IP address or doesn't like the confidence factor. The “Confidence Level” is a number determined by the authentication service based on a number of factors, such as the accuracy of the user in navigating the graphic security protocols, length of time required to select the correct locations, length of time at that IP address.

Those skilled in the art will appreciate that the present invention may be subject to variations and modifications other than those specifically described. It is to be understood that the present invention encompasses all such variations and modifications that fall within its spirit and scope.

1. A system for authenticating a user to a remote computer system comprising:
A remote computer system containing a resource or application accessible to authorized users and having a list of authorized users;
An authentication system that is contacted by the remote computer system and is provided with the identification of a presumptively authorized user seeking to access the remote computer system;
The authentication system containing one or more graphics and locations previously created by the user and stored on the authentication system;
The authentication system providing one or more of the stored graphics to the user's computer screen and logging the locations selected by the user in response to these one or more graphics; and
The authentication system comparing the logged locations with the stored locations and if they are within a specified tolerance, authenticating the user to the remote computer system.

2. The system of claim 1, comprising an authentication system whereby the user is shown more than one graphic and required to identify a specific location that graphic.

3. The system of claim 2, where the system includes three graphics, one including a group of people, one including more than one place, and one including more than one thing, and the user being required to correctly identify the person, place and thing in the three graphics to authentic himself to the system.

4. The system of claim 1, where the system incorporates linear and/or wrap-around movement so that the graphic moves on the user's computer screen.

5. The system of claim 1, where one or more image is distorted.

6. The system of claim 1, where a large image is provided, requiring the user to zoom in to identify the pre-selected location.

7. The system of claim 1, where one or more images, including images not preselected by the user, dissolve into one another.

8. A system for authenticating a user to a remote computer system comprising:
A remote computer system containing a resource or application accessible to authorized users and having a list of authorized users;
An authentication system that is contacted by the remote computer system and is provided with the identification of a presumptively authorized user seeking to access the remote computer system;
The authentication system containing one or more graphics previously created by the user and stored on the authentication system;
The authentication system generating an moving image with multiple graphics of a type similar to the stored graphics and including one user-determined stored graphic to the user's computer screen and logging the location selected by the user in response to the moving image;
The authentication system comparing the logged locations with the location of the user-determined stored graphic at the time the user's location was logged and if the two locations are within a specified tolerance, authenticating the user to the remote computer system.

9. The system of claim 8 where the graphic is a user entered hand-drawn glyph.

10. The system of claim 8 where the moving image is a group of bubbles.

11. A system for authenticating a user to a remote computer system comprising:
A remote computer system containing a resource or application accessible to authorized users and having a list of authorized users;
An authentication system that is contacted by the remote computer system and is provided with the identification of a presumptively authorized user seeking to access the remote computer system;
The authentication system containing one or more graphics and locations previously created by the user and stored on the authentication system;
The authentication system providing one or more of the stored graphics to the user's computer screen and logging the locations selected by the user in response to these one or more graphics;
The authentication system comparing the logged locations with the stored locations and if they are within a specified tolerance, authenticating the user to the remote computer system.
